(19) United States
(12) Patent Application Publication
(10) Pub. No.: US 2018/0327293 A1
(43) Pub. Date: Nov. 15, 2018

(54) APPARATUS AND PROCESS FOR THE REMOVAL OF NITROGEN FROM WASTEWATER

(71) Applicant: Daniel P. Smith, Tampa, FL (US)

(72) Inventor: Daniel P. Smith, Tampa, FL (US)

(21) Appl. No.: 15/593,054

(22) Filed: May 11, 2017

(51) Int. Cl. C02F 3/30

(52) U.S. Cl. CPC C02F 3/301; C02F 2101/16; C02F 3/307

(57) ABSTRACT

The present invention is for a nitration/anammox (NIT-ANM) process for removal of wastewater nitrogen in a saturated porous media biofilter. The oxygen is supplied through a plurality of tubes having permeable membrane walls for bleeding the oxygen into the wastewater surrounding the tube. The nitritation and anammox bioreaction takes place in the wastewater submerged around granular media. Oxygen is supplied through the tubes and bled through the submerged permeable membrane tube walls at a limited rate to support nitritation of a portion of wastewater ammonia to nitrite, followed by an anammox conversion of nitrite and wastewater ammonium to nitrogen gas (N2).

### FIELD OF THE INVENTION

This invention relates to the removal of nitrogen from wastewater using anammox bacteria and especially to a permeator-oxygenated anammox nitritation biofilter for the removal of nitrogen from wastewater.

### BACKGROUND OF THE INVENTION

In the past nitrogen removal from ammonium rich wastewater was accomplished in two steps. The first step is nitrification, to transform ammonium to nitrate, which is accomplished by the aerobic ammonia and nitrite oxidizing bacteria and then by a separate denitrification process to transform nitrate to nitrogen gas. This latter is carried out by denitrifiers to reduce nitrate to nitrogen gas (N₂) with the input of a suitable electron donor. These processes require two completely different sets of conditions and in addition to using large amounts of energy and using a significant amount of chemicals, such as methanol, they also produce an excess amount of sludge and produce a significant amount of green house gases, such as CO₂ and N₂O, and ozone depleting nitrogen oxide (NO).

More recently, Anammox (ANerobic AMMonium OXidation) has been used to convert nitrite and ammonium ions directly into diatomic nitrogen and water:

NH₄₊+NO₂—→N₂+2H₂0

Removal of ammonium in wastewater treatment using Anammox consist of two separate processes. The first step is the partial nitrification (or nitritation) of part of the ammonium to nitrite by ammonia oxidizing bacteria:

2NH₄₊+3O₂→2NO₂—+4H₊+2H₂O

Then the resulting ammonium nitrite is converted in the anammox process to dinitrogen gas and nitrate by anammox bacteria.

NH₄₊+NO₂—→N₂+2H₂O

Zeolite, commonly as clinoptilolite, is used in wastewater treatment systems to absorb ammonia. In wastewater systems, it requires periodic removal for regeneration, such as by brine, air stripping, or the like, which requires the shutdown of the water treatment system. Zeolite removes ammonium from the wastewater but further processing is required to convert the ammonium to nitrate or nitrogen gas.

Prior U.S. Patent Publication US 2015/0151996 (as corrected in Publication US 2016/0207809) to Collison teaches a self-regulated zeolite reactor for sustainable ammonium removal from wastewater. The process is for a biologically regenerating zeolite in-situ so that the process can be continuous and sustainable. Zeolite immobilizes ammonium ions by cation exchange to provide a food source for ammonia eating bacteria and wicks up water to provide sufficient aeration to oxidize the ammonia. The invention establishes an oxyline boundary between aerated and anoxic zones to allow bacteria from different zones to exist in close proximity.

Prior U.S. Patent Publication US 2005/0087489 to Tal et al. teaches an anaerobic ammonium oxidation for water treatment in a recirculating fish tank. It uses a two stage filtration system in which the aquarium water is fed through a nitrification filter first and then through an anammox filter and back into the aquarium. One embodiment has the filtering process having the nitrification and anammox systems together but separated by a sharp oxygen gradient filter. The lower part of the filter is oxygenated to allow ammonia oxidizing bacteria to convert some of the ammonia to nitrite, while the upper part of the filter operates under anaerobic conditions to activate the ammonia organisms which oxidize the remaining ammonia to nitrogen gas using nitrite as an electron acceptor.

My prior patent application Ser. No. 14/190,266 is for a method of recovering nitrogen from wastewater. A multi-chamber ion exchange bioreactor is incorporated into a septic tank system and has an anaerobic treatment chamber therein having a solid blanket containing anaerobic bacteria therein, followed by a multi-chamber ion exchange bioreactor having a plurality of ion exchange chambers forming a serpentine passage having each upflow chamber followed by a downflow chamber for the removal of nitrogen compounds from the effluent passing therethrough.

The present invention is for an apparatus and method of removing nitrogen from wastewater using an anammox process. The wastewater is fed to a chamber filled with a saturated porous media and having a plurality of tubes therein. The tubes form a nitritation/anammox biofilter for the removal of nitrogen in the wastewater. The tubes supply oxygen through permeable membrane walls to support nitrification. Oxygen is supplied through the tubes and through the submerged permeable membrane at a limited rate to support nitritation of a portion of ammonium in a saturated porous media.

### SUMMARY OF THE INVENTION

The present invention is for a nitritation/anammox (NIT-ANM) process for removal of wastewater nitrogen in a saturated porous media biofilter. The oxygen is supplied through a plurality of tubes having permeable membrane walls in which each tube bleeds oxygen therethrough into wastewater submerged in a granular media. The oxygen supplied through the tube walls supports nitritation of a portion of the wastewater ammonia to nitrite, followed by an anammox conversion of nitrite and wastewater ammonium to nitrogen gas (N2).

### BRIEF DESCRIPTION OF THE DRAWINGS

The accompanying drawings, which are included to provide further understanding of the invention, are incorporated in and constitute a part of the specification and illustrate an embodiment of the invention and together with the description serve to explain the principles of the invention.

In the drawings:

FIG. 1 is a side sectional view taken through a biofilter tube in a wastewater treatment chamber in accordance with the present invention;

FIG. 2 is a sectional view taken through the biofilter tube of FIG. 1;

FIG. 3 is a sectional view of one embodiment of a nitrogen removal chamber using the biofilter tubes of FIGS. 1 and 2;

FIG. 4 is a sectional view of a second embodiment of a nitrogen removal chamber using the biofilter tubes and having an anaerobic upflow chamber; and

FIG. 5 is a sectional view of a third embodiment of a nitrogen removal chamber using the biofilter tubes and having a separate denitrification chamber;

### DETAILED DESCRIPTION OF AN EXEMPLARY EMBODIMENT

The present invention is for an apparatus and method of removing nitrogen from wastewater. The wastewater is fed into an anaerobic vault chamber, or the like, filled with a saturated porous media, such as zeolite with ionic exchange properties, expanded clay or shale. A plurality of tubes each with permeable membrane walls are mounted in the chamber. The chamber fills with incoming wastewater covering at least a portion of the porous media and tubes. The tubes bleed limited amounts of oxygen through the permeable walls into the wastewater to cause a limited aerobic nitritation of wastewater adjacent the tube walls to support nitritation of a portion of the wastewater to convert a portion of the ammonium in the wastewater to nitrite. An anammox conversion by microorganisms then converts the produced nitrite and wastewater ammonium to nitrogen gas (N2). The partial nitrification and the anammox processes (NIT-ANM) take place within a single vault chamber holding the wastewater.

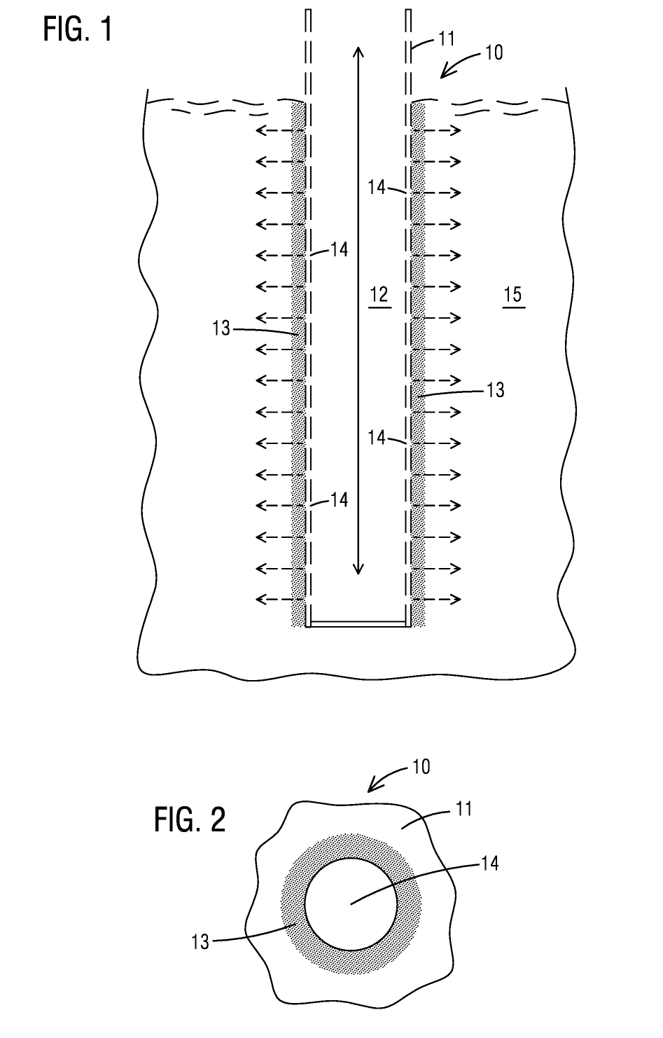

As seen in FIGS. 1 and 2, a cross-section of a permeable membrane tube 10 has an oxygen permeation wall 11 forming a passageway 12 for the passing of oxygen in the form of air or other gases having varying concentrations of oxygen or pure oxygen. The tube 10 walls 11 can be seen with a nitritation/anammox (NIT-ANM) bio-reaction surface 13 therearound and surrounding granular media 14. The tube 10 is shown in wastewater 15. Arrows illustrate the transport of oxygen through the oxygen permeation wall 11.

The nitritation/anammox (NIT-ANM) process removes wastewater nitrogen using a saturated porous media bio-filter where oxygen is bled through the walls to aerate submerged wastewater around granular media adjacent the submerged oxygen permeable surfaces 11. The filter walls may be a dense membrane wall 11 in which oxygen is transported across the membrane by diffusion through the membrane material itself. Alternatively, the membrane walls may be porous, in which oxygen is transported across the membrane by diffusion or advection through pores in the membrane. Oxygen is supplied from air or other gas containing oxygen including air or enriched air or pure oxygen fed through the tube 10 lumen 12. Wastewater 15 is in contact with the submerged granular media 14 which may include expanded clay, expanded shale, zeolites with ionic exchange properties including clinoptilolite and chabazite and media mixtures including these and other media as desired. The submerged oxygen permeation tubes 10 are partially in contact with the atmosphere and extend below the water 15 surface. Oxygen is transported by advection and diffusion across the permeable tubes 10, walls 11. A packed bed of submerged granular media is placed on the wastewater 15 side of the permeable membrane tubes 10. Oxygen is supplied from the submerged permeable membrane tube walls 11 at a limited rate to support (aerobic) nitritation of only a portion of wastewater ammonium to nitrite, followed by conversion of the produced nitrite and a portion of wastewater ammonium to nitrogen gas through anammox conversion by microorganisms attached to the granular media 14 in the pore water.

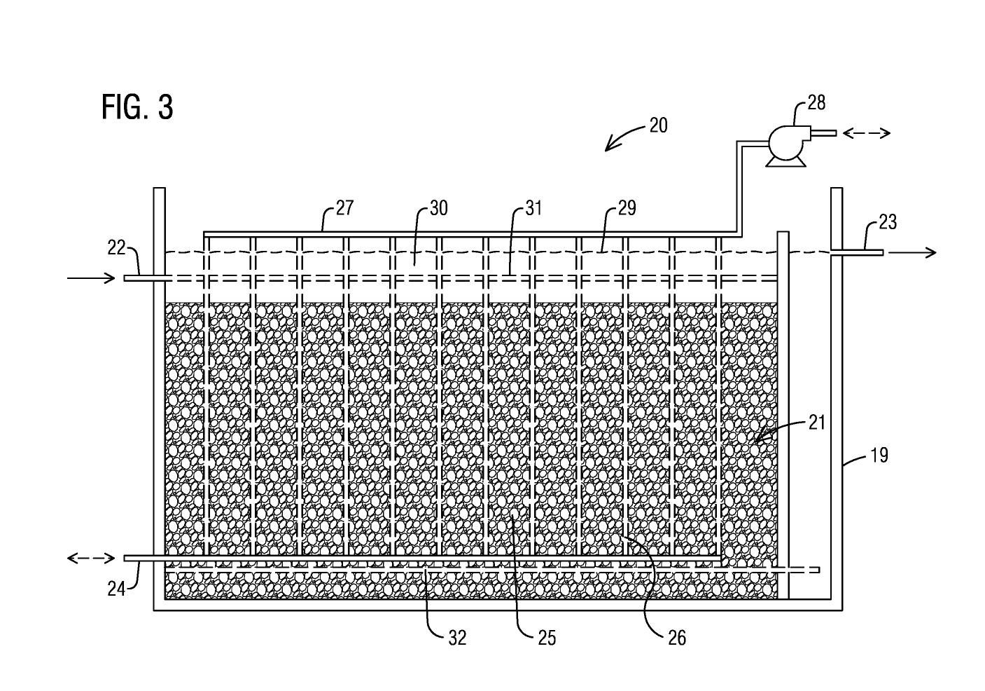

Referring to FIG. 3, an NIT-ANM bioreactor 20 has a vault or container 19 having a chamber 21 having a wastewater inlet 22 and an outlet 23 and an air inlet and outlet 24. The chamber is at least partially filled with a granular media 25 and has a plurality of permeable membrane tubes 26 mounted therein connected to an air manifold 27 and to the air inlet and outlet 24 at the other end. An air circulator 28 is connected to the air manifold 27 for moving air through the manifold 27. Air movement through manifold 27 can be either way into or out of the manifold. The NIT-ANM bio-reactor of FIG. 3 has vertical wastewater flow, vertical orientation of oxygen permeation tubes 26 that are connected for gas to flow with forced circulation. Influent wastewater 30 enters the NIT-ANM bioreactor 20 and proceeds through an inlet distribution pipe 31. The water surface 29 provides head for water flow into an infiltrative surface and through the granular biofiltration media 25. Gas is supplied and collected via gas manifold 27 to and from submerged oxygen permeation tubes that extend into the granular media bed 25. The gas can move into, through, and out the submerged oxygen permeation tubes. Wastewater is then collected in an effluent collection pipe 32 which conveys the wastewater effluent 30.

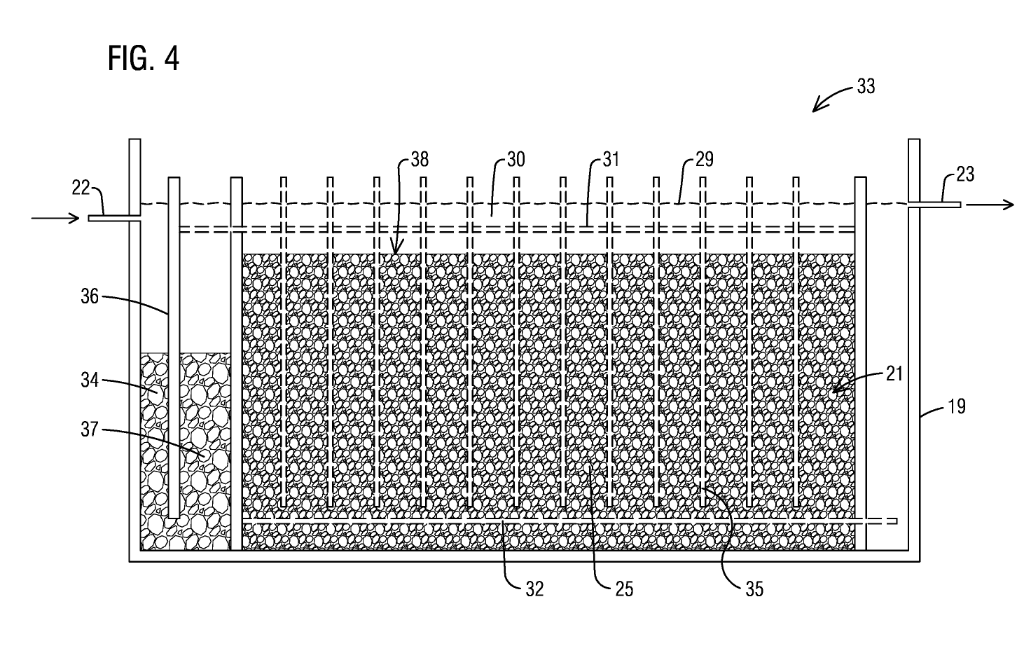

FIG. 4 illustrates another embodiment of the NIT-ANM bioreactor 33 which is similar to FIG. 3 but is preceded by an anaerobic upflow chamber 34. The bioreactor 33 vault 19 has the inlet 22 and outlet 23 and the inlet distribution pipe 31 along with the effluent collection pipe 32. Chamber 21 is filled with a packed bed of granular media 25. This embodiment has vertical wastewater flow, vertical orientation of oxygen permeation surfaces, oxygen permeation tubes 35 that are unconnected, and an anaerobic upflow chamber preceding the NIT-ANM bioreactor. Influent wastewater enters a downflow passageway 36 and then passes upwards through an anaerobic solid blanket 37. Water enters a flow distribution pipe 31 with the water providing a head for water flow into the infiltrative surface 38 and through the granular biofiltration media 25. The submerged oxygen permeation tubes 35 extend into the granular media bed without end connections. Wastewater is collected in the effluent collection pipe 32 which conveys the wastewater effluent through outlet port 23. This embodiment uses a free convection system having free air movement without positive air circulation.

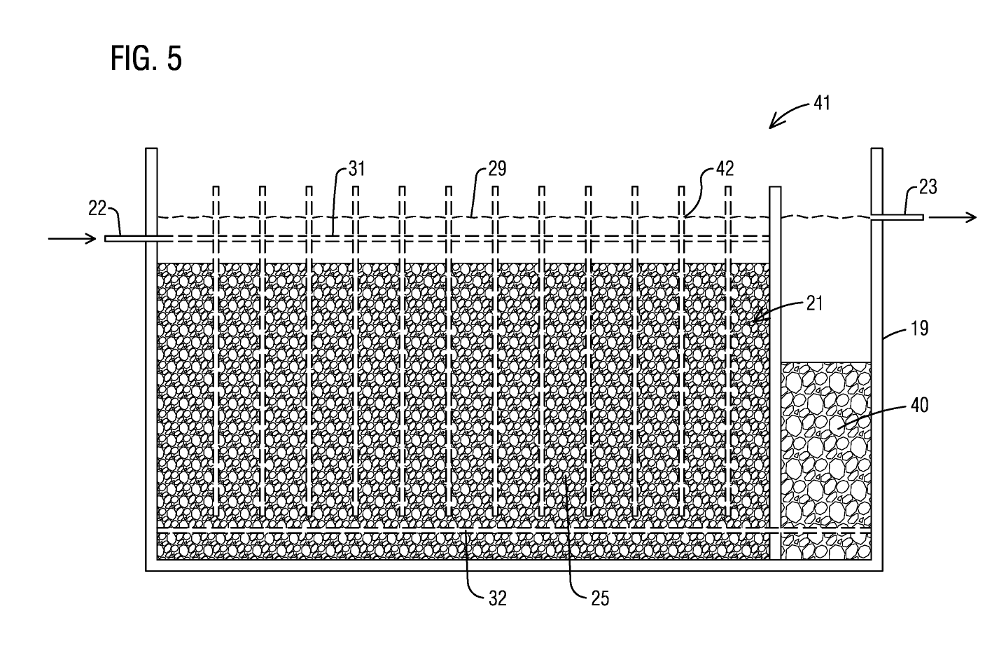

FIG. 5 is similar to FIGS. 3 and 4 but is followed by a denitrification chamber 40. The bioreactor 41 vault 19 has the inlet 22 and outlet 23 and the inlet distribution pipe 31 along with the effluent collection pipe 32. Chamber 21 is filled with the granular media 25. This NIT-ANM bioreactor has vertical wastewater flow, vertical orientation of oxygen permeation surfaces, oxygen permeation tubes 42 that are unconnected and a denitrification chamber 40 following the NIT-ANM. Influent wastewater provides a head for water flow into an infiltrative surface and through the granular biofiltration media 25. Submerged oxygen permeation tubes 42 extend into the granular media 25 without end connections. Wastewater is collected in an effluent collection pipe which conveys the wastewater through the upflow denitrification biofilter chamber 40 and then to the outlet 23.

In each embodiment disclosed the permeable membrane orientation may be vertical, horizontal, sloped or any combination thereof and the water flow can also follow any water flow orientation.

It should be clear at this time that a method and apparatus for removal of nitrogen from wastewater using anammox bacteria has been provided. The invention can also be applied for nitrogen removal to dilute wastewater including primary and effluent secondary effluent as well as higher nitrogen levels. It may also remove carbonaceous biochemical oxygen demand alongside nitrogen removal. However the present invention is not to be considered limited to the forms shown which are to be considered illustrative rather than restrictive.

I claim:

1. A process for removing nitrogen from wastewater comprising:
selecting a generally anaerobic vault chamber for the collection of wastewater therein, said chamber having a wastewater inlet and a wastewater outlet;
attaching a plurality of hollow oxygen permeation tubes in said tank for the transmission of oxygen therethrough and for feeding oxygen through the walls of said tubes;
adding a granular media supporting anammox bacteria to said chamber surrounding said tubes;
passing wastewater into said tank surrounding said media and tubes; and
passing oxygen through said tube walls to cause a limited aerobic nitritation of wastewater adjacent said tube walls to support nitritation of a portion of wastewater ammonium to nitrite followed by an anammox conversion of the produced nitrite and a wastewater ammonium to N2 gas.

2. The process for removing nitrogen from wastewater in accordance with claim 1 in which said plurality of hollow oxygen permeation tubes is composed of porous membranes.

3. The process for removing nitrogen from wastewater in accordance with claim 1 in which said plurality of hollow oxygen permeation tubes is composed of a dense, non-porous membrane.

4. The process for removing nitrogen from wastewater in accordance with claim 1 in which said granular media includes a zeolite with ionic exchange properties.

5. The process for removing nitrogen from wastewater in accordance with claim 1 in which said granular media includes clinoptilolite.

6. The process for removing nitrogen from wastewater in accordance with claim 1 in which said granular media includes chabazite.

7. The process for removing nitrogen from wastewater in accordance with claim 1 in which said granular media includes expanded shale.

8. The process for removing nitrogen from wastewater in accordance with claim 1 in which said granular media includes expanded clay.

9. The process for removing nitrogen from wastewater in accordance with claim 1 in which said granular media includes mixtures of zeolites, expanded clay and expanded shale.

10. An apparatus for removing nitrogen from wastewater comprising:
a wastewater collection vault having a generally anaerobic vault chamber having a wastewater inlet and a wastewater outlet, said vault chamber being charged with ammonia oxidizing bacteria and with anammox bacteria;
a plurality of hollow oxygen permeation tubes mounted in said vault chamber, said hollow oxygen permeation tubes being coupled to a source of oxygen for the transmission of oxygen therethrough and for bleeding oxygen through the walls thereof; and
granular media at least partially filling said vault chamber surrounding said hollow oxygen permeation tubes mounted therein;
whereby wastewater entering said vault chamber converts ammonium to nitrite and ammonium and nitrite are converted to nitrogen gas in said vault chamber.

11. The apparatus for removing nitrogen from wastewater in accordance with claim 10 in which each of said plurality of hollow oxygen permeation tubes is composed of a dense, non-porous membrane.

12. The apparatus for removing nitrogen from wastewater in accordance with claim 10 in which each of said plurality of hollow oxygen permeation tubes is composed of a porous membrane.

13. The apparatus for removing nitrogen from wastewater in accordance with claim 10 in which said granular media includes a zeolite with ionic exchange properties.

14. The apparatus for removing nitrogen from wastewater in accordance with claim 10 in which said granular media includes clinoptilolite.

15. The apparatus for removing nitrogen from wastewater in accordance with claim 10 in which said granular media includes chabazite.

16. The apparatus for removing nitrogen from wastewater in accordance with claim 10 in which said granular media includes expanded shale.

17. The apparatus for removing nitrogen from wastewater in accordance with claim 10 in which said granular media includes expanded clay.

18. The apparatus for removing nitrogen from wastewater in accordance with claim 10 in which said granular media includes a mixture of zeolite, expanded clay and expanded shale.

19. The apparatus for removing nitrogen from wastewater in accordance with claim 10 having an air circulator providing air under pressure to said hollow oxygen permeation tubes mounted in said vault chamber.

20. The apparatus for removing nitrogen from wastewater in accordance with claim 10 in which oxygen supply is by passive means through said hollow oxygen permeation tubes mounted in said vault chamber without forced air circulator.
